(19) United States
(12) Patent Application Publication
(10) Pub. No.: US 2008/0183303 A1
(43) Pub. Date: Jul. 31, 2008

(54) Operator interface device for HMI system

(76) Inventor: Scott A. West, Collingwood (CA)

Correspondence Address: LITMAN LAW OFFICES, LTD., P.O. BOX 15035, CRYSTAL CITY STATION, ARLINGTON, VA, 22215, US

(21) Appl. No.: 11/698,041

(22) Filed: Jan. 26, 2007

(51) Int. Cl. G06F 17/00

(52) U.S. Cl. 700/2

(57) ABSTRACT

The operator interface device for an HMI system provides for generic, simple communication between Human-Machine Interface (HMI) software and an operator workstation. The device has at least one signaling device, at least one serial communication port, and an Ethernet port mounted on a housing. Disposed within the housing is electronic circuitry that includes a microcontroller having embedded Ethernet capability. The microcontroller is configured to pass serial data from a bar code reader, RFID receiver, or the like from the serial communication port via Ethernet by TCP/IP to the HMI software on a remote server, and to control driver(s) for the at least one signaling device, which may be a beacon, a light, a horn or other audio device, or a push button switch. The device may also include a power supply and miniconnector port for passing signals between a machine controller, such as a torque controller, and the HMI software.

### BACKGROUND OF THE INVENTION

1. FIELD OF THE INVENTION

The present invention relates to control systems for automated commercial and industrial environments, such as a control system for an assembly line, and particularly to an operator interface device for an HMI (Human-Machine Interface) system that provides for simple, generic communication between an operator work station and HMI software running on a server.

2. DESCRIPTION OF THE RELATED ART

Many commercial, industrial, warehouse, and manufacturing establishments resort to automation in order to reduce labor costs and increase efficiency. Automated systems often are computer-controlled. Typically, the computer will be located at a central location and will control a plurality of operator work stations distributed throughout the establishment remote from the central location.

Machines are used to move products and components from one location to another, to assemble products, to package products, and to perform other services related to the nature of the establishment. Human operators may be located at the operator work stations to operate various machines at the work stations, position components, monitor machine processes, and troubleshoot problems that may occur at the remote locations.

A typical model for such a system is the Supervisory Control and Data Acquisition Model (SCADA) model. A SCADA system customarily includes input and output signal hardware connected to the machines, a plurality of Remote Terminal Units (RTU) or Programmable Logic Controllers (PLC) connected to the hardware, a central station running HMI software connected to the RTUs or PLCs, and a communications infrastructure for communicating between the components. The signal hardware will typically include some sort of alarm, either as a horn or other audio device, or in the form of light signals r beacons, or both.

A problem with this approach is that the hardware signal devices and the PLCs or RTUs are custom selected for the particular application. PLCs, for example, were originally developed to replace systems of relays and switches in automation systems, and used simple logic circuits and “ladder logic” of the type that an electrician or electronics technician could follow and program from an electrical schematic diagram. PLCs have advanced to use block programming languages and, in some cases, structured programming languages; nevertheless, PLCs retain their circuit-based roots and still must be customized by an electrician to interface with particular hardware implementations, which is both expensive and time consuming. RTUs suffer from much the same problem.

An automotive assembly line, for example, requires multiple operator workstations, each of which requires input/output signal hardware and a PLC to interface with HMI software, such as GE Fanuc's Proficy® or Cimplicty® HMI software, Allen-Bradley/Rockwell Automation HMI, Wonderware HMI, and the like. At costs in the tens of thousands per workstation for installation of fifty to one hundred work stations per division or per plant, together with the down time when workstations require maintenance, repair, replacement, or upgrading, plant efficiency suffers.

Consequently, there is a need for a generic operator workstation unit for HMI systems that operates directly under Information Technology (IT) control without requiring custom installation. Thus, a hardware interface device solving the aforementioned problems is desired.

### SUMMARY OF THE INVENTION

The operator interface device for an HMI system provides for generic, simple communication between Human-Machine Interface (HMI) software and an operator workstation. The device has at least one signaling device, at least one serial communication port, and an Ethernet port mounted on a housing. Disposed within the housing is electronic circuitry that includes a microcontroller having embedded Ethernet capability. The microcontroller is configured to pass serial data from a bar code reader, RFID receiver, or the like from the serial communication port via Ethernet by TCP/IP to the HMI software on a remote server, and to control driver(s) for the at least one signaling device, which may be a beacon, a light, a horn or other audio device, or a push button switch. The device may also include a power supply and miniconnector port for passing signals between a machine controller, such as a torque controller, and the HMI software.

The at least one serial port may be an RS-232 port. Assembly lines, parts warehouses, and other industrial establishments frequently use bar code readers, RFID receivers or transceivers, and other devices that communicate with automation control software via the RS-232 standard, so that such devices, sometimes termed legacy devices, are often equipped with RS-232 cables and jacks. Alternatively, or in addition to the RS-232 port, the at least one serial communication port may be a Universal Serial Bus (USB) port for connection with sensors or input/output devices so equipped, or to a printer, touch screen monitor, keyboard, mouse, or other input device located at the operator workstation. In another alternative, the serial port may be a DeviceNet, Seriplex, Modbus, or other serial communication port.

The at least one signaling device may be a beacon, preferably disposed on top of the housing. The beacon may comprise an LED array, and the device may include a circuit to flash the LED array on instruction from the HMI software to indicate an error at the workstation requiring intervention by the human operator. A driver circuit for turning the beacon on is disposed in the housing, and an oscillator or timing circuit for switching the array on and off at the desired frequency may be incorporated into the microcontroller, or may be supplied as a discrete circuit with the LED driver.

The signaling device may be one or more lights, preferably disposed on the front face of the housing, which may also comprise LED arrays with the driver circuitry disposed in the housing. The lights may include, for example in the case of an assembly line, a green lamp to indicate that work on the product at the workstation is proceeding satisfactorily, a light to indicate that a product on the conveyor belt as arrived on station at the operator workstation, a light that may flash or otherwise indicate that a nonstandard or custom part is required for the product currently at the workstation, etc.

The signaling device may be a speaker, horn, or other audio device with driver circuitry disposed in the housing that is switched on upon a signal received by the microcontroller from the HMI software via Ethernet. The audio device may be a speaker driven by a speech processor disposed within the housing, if desired.

The signaling device may include one or more push buttons operable by the human operator to send a signal to the HMI software. For example, a start button may be provided to signal to the HMI software that an error condition has been corrected and the assembly line may be restarted, or a release button to signal that the error cannot be corrected within the time allotted and that the assembly line can be released or restarted, but the product has been removed from the belt or needs to be diverted for further processing at an appropriate juncture in the assembly line.

The miniconnector may be a six-pin connector providing power to, and receiving inputs from, up to four controllers or sensors located at the workstation. The miniconnector is wired to pass discrete input/output signals to and from the microcontroller, which simply passes the signals on to and from the server. The miniconnector may be an M12 connector. The device may have a plurality of miniconnectors mounted in the housing.

The device may include more than one Ethernet port so that a plurality of operator interface units can be cascaded on the network. Alternatively, the extra Ethernet port may be used for connecting anything that may operate by an Ethernet connection to the network, such as a computer, a printer, a sign, etc. A software driver for meshing the operator interface unit with the HMI software provides a rudimentary command structure proper correlation of communications between the HMI software and one or more human interface units, much as a printer driver controls communication between a computer and a printer.

Thus, the human interface device for an HMI system provides a generic communication between a human operator at a remote workstation with the HMI software by IT control, without the need for custom input/output hardware and a custom PLC, RTU, or other intermediate device at the workstation.

These and other features of the present invention will become readily apparent upon further review of the following specification and drawings.

### BRIEF DESCRIPTION OF THE DRAWINGS

FIG. 1 is a front perspective view of an operator interface device for an HMI system according to the present invention.

FIG. 2 is a bottom view of the operator interface device of FIG. 1.

FIG. 3 is a block diagram of the electronic circuits disposed within the operator interface device of FIG. 1.

FIGS. 4A and 4B are a schematic diagram showing the pinouts of an exemplary microcontroller for the operator interface device of FIG. 1.

FIG. 5 is a schematic diagram of an RS-232 input port circuit for the operator interface device of FIG. 1.

FIGS. 6A and 6B are a schematic diagram of an Ethernet isolation circuit for the operator interface device of FIG. 1.

FIG. 7 is a front perspective view of an alternative embodiment of an operator interface device for an HMI system according to the present invention.

Similar reference characters denote corresponding features consistently throughout the attached drawings.

### DETAILED DESCRIPTION OF THE PREFERRED EMBODIMENTS

The operator interface device for an HMI system provides for generic, simple communication between Human-Machine Interface (HMI) software and an operator workstation. A typical application for the device might be at an operator workstation in an assembly line at an automotive manufacturing facility. The device provides for generic communication between a human operator and the HMI software, eliminating the need for custom devices at the workstation that communicate with the HMI software through a programmable logic controller that would also have to be custom programmed.

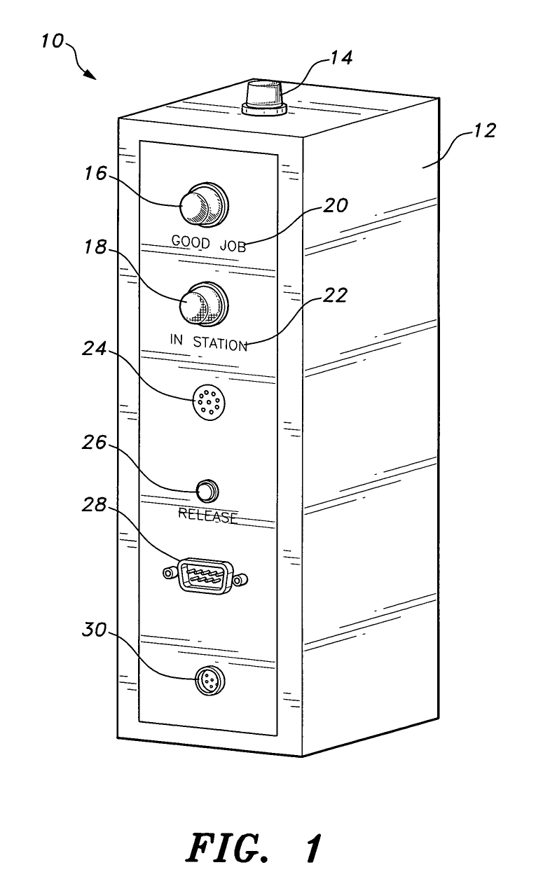

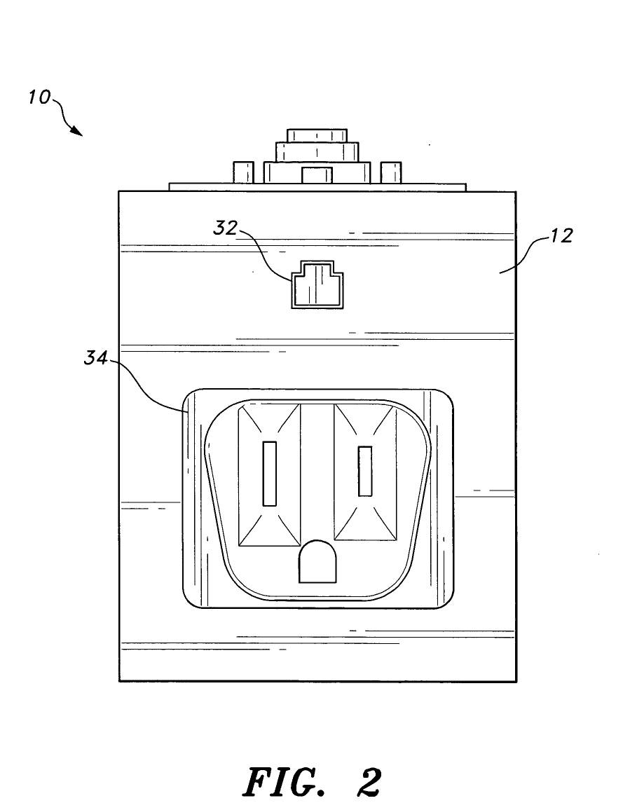

FIGS. 1 and 2 show a perspective view and a bottom view, respectively, of a first embodiment of the device, designated generally as 1 0 in the drawings. The device 10 includes a housing 12. The housing 12 may have any desired configuration. The embodiment shown in FIG. 1 has an elongated housing that may have a wall-mounting bracket on its rear face or wall mounting tabs extending from the top and bottom (not shown).

The device 10 has at least one signaling device, at least one serial communication port, and an Ethernet port mounted on the housing 12. The embodiment of the device 12 shown in FIGS. 1 and 2 has a beacon 14 mounted on the top face of the housing 12, and a first signal light 16 and a second signal light 18 disposed on the front face of the housing 12. The beacon 14 and the signal lights 16 and 18 may comprise a light emitting diode (LED) or array of light emitting diodes having different color lenses to provide a visual indication of the different messages being conveyed. The beacon 14, e.g., may comprise a red lens to signal an error condition or fault at the workstation requiring intervention by the human operator. The first light 16 may have a green lens and appropriate indicia 20, such as “GOOD JOB”, disposed upon the housing 12 to indicate that work at the workstation is proceeding satisfactorily. The second light 18 may have an amber lens and appropriate indicia 22, such as “IN STATION”, disposed on the housing 12 to indicate, e.g., that there is a product on the assembly line that has arrived at the workstation for processing.

The number of visual signals, their location on the housing 12, their configuration, and the signal being conveyed by illumination of the visual signals may vary within the scope of the invention. Also, as described below, the beacon 14 and/or the signal lights 16 and 18 may flash or pulse to draw the attention of the human operator to the visual signal, or to convey a particular message relating to the state of the assembly line or the product that is currently located at the work station.

The device 10 may include an audio signaling device with a speaker 24 mounted on the front face or front panel of the housing 12 in addition to, or instead of, visual signaling devices. The audio signaling device may simply be a horn or buzzer, or the device 10 may include a speech synthesizer for conveying short, standard voice signals. The audio signaling device may be used in conjunction with the visual signaling device, e.g., the light 18 may illuminate to indicate a product has arrived at the workstation, and the audio signaling device may beep to indicate special processing of this particular product is required.

The device 10 may include a push button 26 disposed on the front face or panel of the housing 12. The push button 26 may be used by the human operator to signal to the HMI software that an error condition at the workstation has been cleared, a required task has been accomplished, or that the error condition cannot be cleared in a time allotted for the task so that the assembly line should be released for continued operation with the product either being removed from the assembly line at the workstation or marked for diversion at an appropriate junction farther down the assembly line. Different messages may be conveyed by providing a plurality of push buttons, or by a particular pattern of pressing the button (number of pushes in a given time period, duration of push, etc.).

The device 10 includes at least one serial communication port. In the embodiment of FIG. 1, the serial communication port comprises an RS-232 port, with a DB-9 connector 28 being mounted on the front panel of the housing 12. Many sensors used on assembly lines are legacy devices that include an RS-232 cable, including bar code scanners, RFID receivers or transceivers, temperature sensors, photocells, etc. The RS-232 connector 28 provides a means for passing a serial communications signal through the device 10 to the HMI software.

The device 10 may further include a miniconnector 30 for connecting a machine controller or sensor to the HMI software. The miniconnector 30 is preferably a six-pin connector providing power to, and receiving inputs from, up to four controllers or sensors located at the workstation. The miniconnector is wired to pass discrete input/output signals to and from the microcontroller, which simply passes the signals on to and from the server. The miniconnector 30 may be an M12 connector. The device may have a plurality of miniconnectors 30 mounted in the housing.

The device 10 includes an Ethernet connector 32 for receiving an RJ-45 jack in order to connect the device 10 the establishment's local area network (LAN) or wide area network (WAN) for providing communication with the HMI software. Ethernet connector 32 may be disposed on the bottom face of the housing. 12. The device 10 also includes a power input connector, such as a recessed male plug 34, for connecting the device 10 to the a.c. power mains. The power input connector 34 may also be disposed on the bottom face of the housing 12. Instead of a recessed male plug 34, the device 10 may have a power cord extending from the housing 12 for connection to the a.c. power mains.

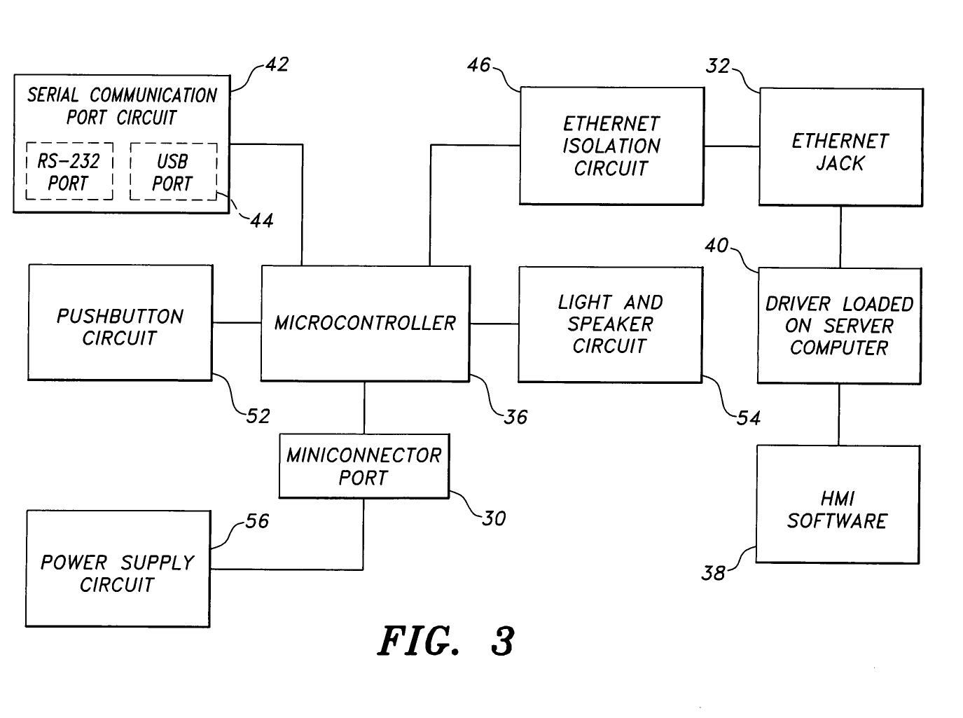

An electrical circuit for providing the device 10 with its functionality is disposed on a printed circuit board or other support within the housing 12. Referring to FIG. 3, the circuitry is built around a microcontroller 36 having embedded Ethernet capability and at least one serial communications interface. It will be understood that the microcontroller is essentially a specialized microprocessor having support circuitry that would otherwise be provided by discrete components (ROM, RAM, serial communications ports, analog-to-digital converters, etc.) disposed upon the same chip, thus providing what is, in essence, a minicomputer without the monitor, keyboard or mouse. By “embedded Ethernet”, Applicant means a single chip implementation of the Ethernet networking standard so that the microcontroller has the capability of communicating by Ethernet without using a computer. Hence, the microcontroller should be capable of setting up a TCP/IP stack, assigning IP addresses, opening ports, forming packets and communicating by TCP/IP protocol, etc.

A microcontroller suitable for use in the device 10 should have at least one serial communications port interface and should be programmable to convert a serial communications signal, particularly one using the RS-232 standard, into packets for transmission via TCP/IP, either by User Data Protocol (UDP) or, more preferably, by Transmission Control Protocol (TCP), so that the HMI software may receive signals from, e.g., a bar code scanner transparently, as though the bar code scanner were connected directly to the server computer running the HMI software. The microcontroller 36 may be programmed to discard the START, STOP, and PARITY bits, sending only the DATA bits in the packets via Ethernet, or may be programmed to packetize all of the bits in the RS-232 signal, so that the TCP/IP signal may be de-packetized and the entire RS-232 restored at the server computer for transmission over a serial communications bus to the HMI software, depending upon the capability of the particular HMI software used by the manufacturing or commercial establishment.

In this regard, the HMI software 38 may be any commercially available brand of HMI software. HMI software generally provides for the collection, monitoring, supervisory control, and sharing of critical production data relating to plant machinery and operations, including sending alarm or control signals to remote locations in the plant. Exemplary HMI software 38 that device 10 may interface with includes GE Fanuc's Proficy® or Cimplicty® HMI software, Allen-Bradley/Rockwell Automation HMI, Wonderware HMI, and the like. The device 10 may be furnished with a software driver 40 that can be loaded on the server computer on which the HMI software resides. The software driver 40 converts software commands from the HMI software 38 into appropriate input commands in the language of microcomputer 36, e.g., to turn on the beacon 14 or audio alarm speaker 24, and conversely, routes output signals from the microcontroller 36 regarding the status of the machine or from push button 26 to the appropriate HMI input in a form required by the HMI software, much in the fashion of a software printer driver.

The microcontroller should be capable of performance that is near real time from a human perspective (100 ms<response time<500 ms), but not so fast that it does not meet the requirements of machine control applications, which require less than 100 ms. The microcontroller should be programmable so that discrete input/output signals from the machine sensors and controllers trigger a hardware IRQ so that the change in input state can be immediately processed. The microcontroller should also be programmable to poll the TCP/IP stack from the HMI software Ethernet receive port frequently (typically 10 ms-500 ms) to maintain close to real-time response to HMI software commands. Preferably the microcontroller is capable of opening a separate TCP/IP port and TCP/IP stack for each serial input device connected to the microcontroller, and a single port for discrete input/output devices connected via the miniconnector 30.

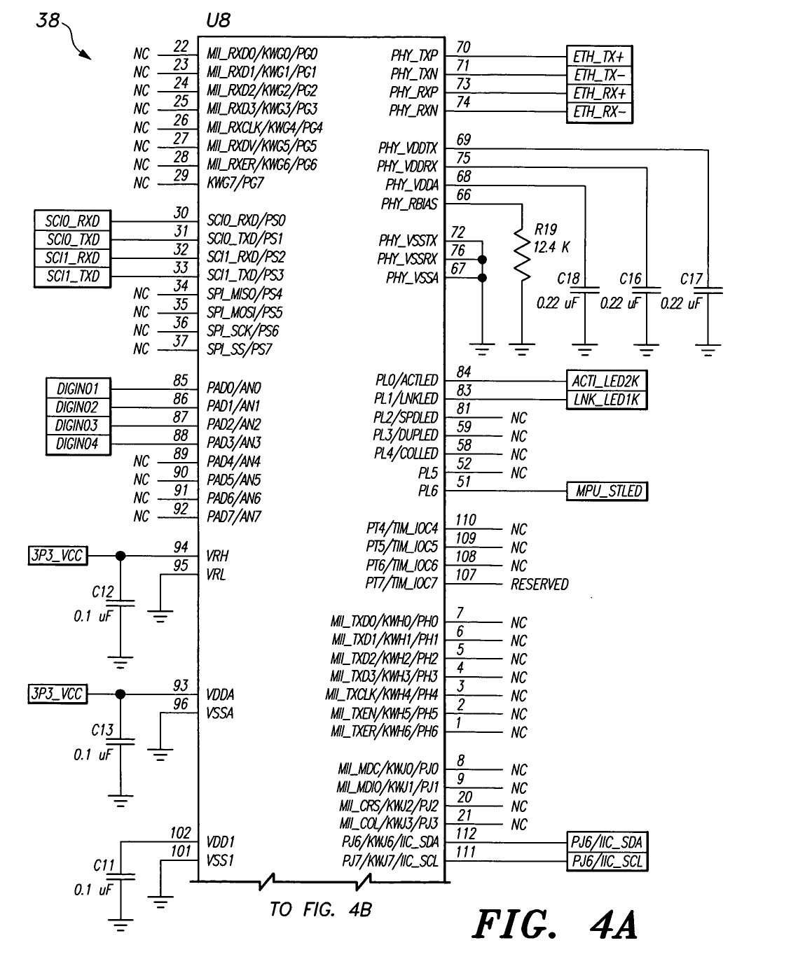

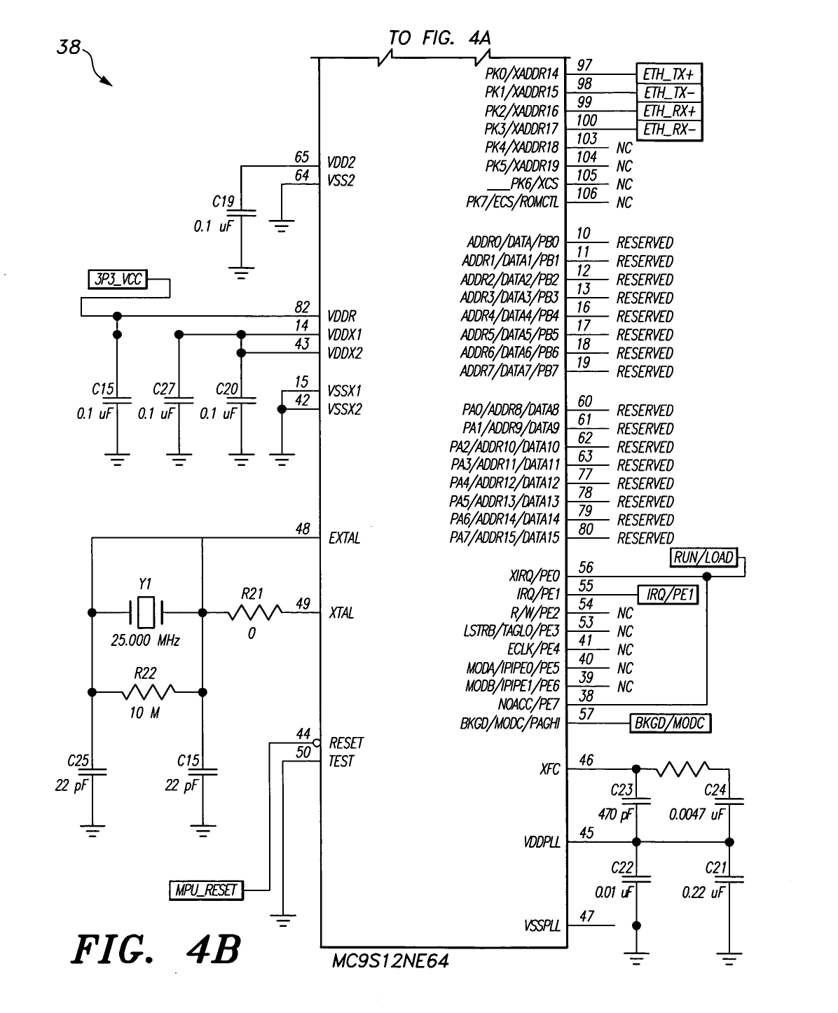

A microcontroller 36 suitable for use in the device is an MC9S12NE64 made by Freescale Semiconductor, Inc. of Austin, Tex. Among other features, this microcontroller features a 15-bit CPU, 64 K bytes of FLASH EEPROM, 6K of RAM, an A/D converter, an Ethernet media access controller (EMAC) with an integrated Ethernet 10/100 Mbps transceiver, two asynchronous serial communications interface modules (SCI), one synchronous serial peripheral interface (unused in the embodiment of FIGS. 1-2), and a 16-bit timer module. The FLASH EEPROM is programmable with a development kit. An exemplary schematic pinout of microcontroller 36 for use in the embodiment of FIGS. 1-2 is shown in FIGS. 4A-4B. It will be noted that in this application, the 16-bit timer is configured to provide a flasher circuit for the beacon 14, and may also be configured to flash lights 16 and 18, if desired.

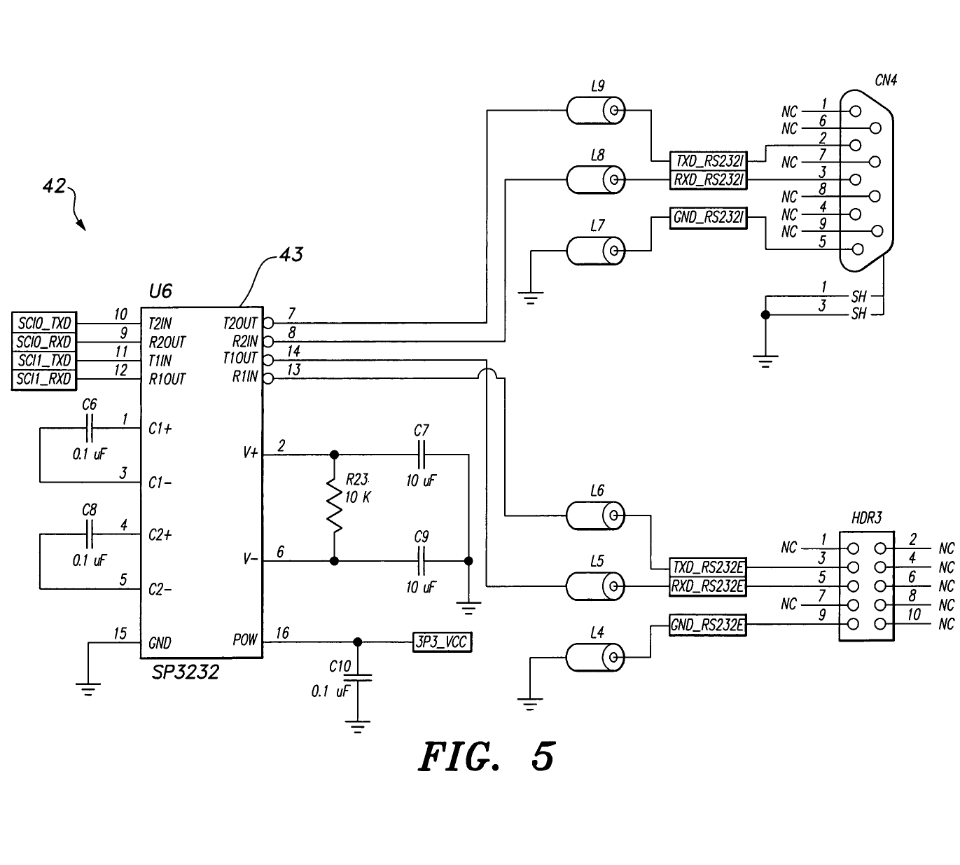

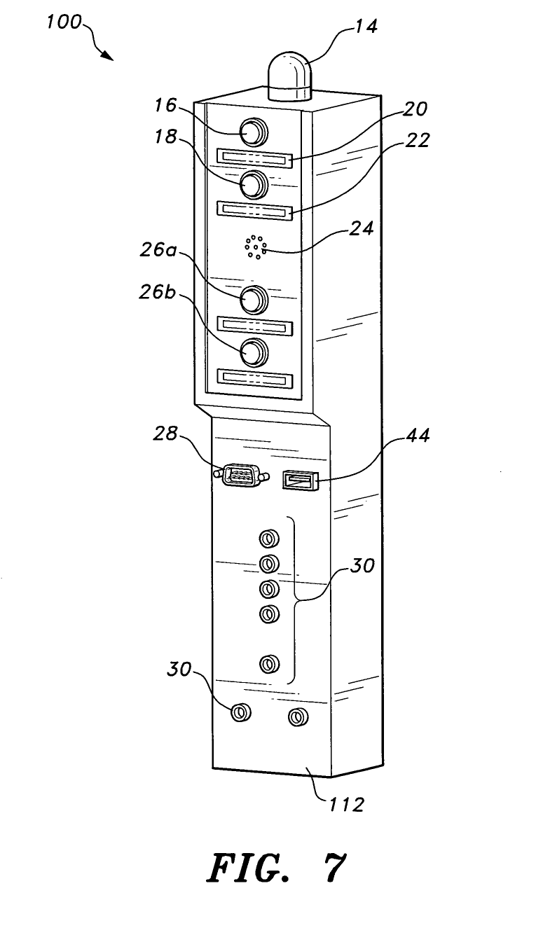

Referring back to FIG. 3, the circuit for 10 includes a serial communication port circuit 42, which may include only a circuit for an RS-232 port, as in the embodiment of the device 10 shown in FIGS. 1 and 2, or may include a circuit for a Universal Serial Bus (USB) port 44 instead or in addition to the RS-232 port, as provided in the alternative embodiment of the device, designated generally as 100, shown in FIG. 7. An exemplary serial communication port circuit 42 for the device 10 of FIGS. 1 and 2 is shown in FIG. 5. The serial communication port circuit 42 is connected by ribbon cable to the DB-9 connector 28, and interfaces with microcontroller 36 via an RS-232 transceiver, e.g., an SP3232 integrated circuit. A similar circuit may be used to interface USB port 44 with microcontroller 36, as is well known in the electronics art.

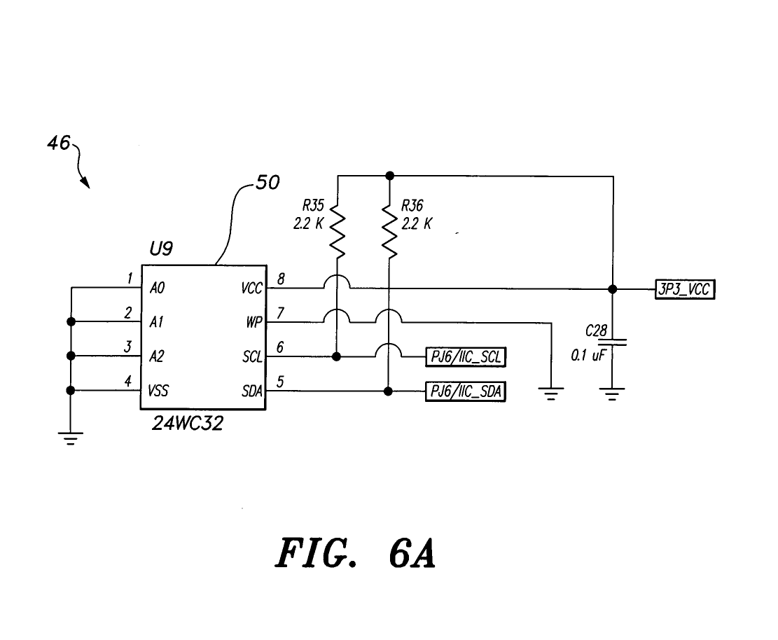

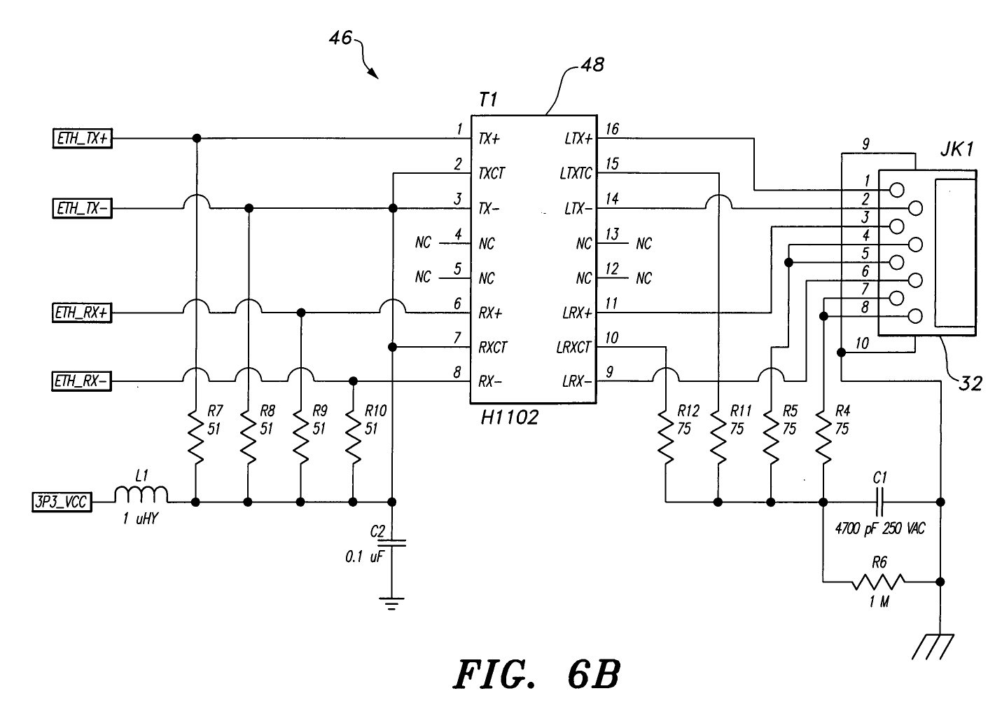

The circuit for device 10 also includes an Ethernet isolation circuit 46 disposed between microcontroller 36 and RJ-45 Ethernet jack 32. The Ethernet isolation circuit 46 is provided to prevent noise carried over the Ethernet cable from affecting the microcontroller 36 through the Ethernet transceiver pins, and to remove noise from signals being transmitted over the Ethernet network cable to the HMI software 38 running on the server computer. An exemplary Ethernet isolation circuit 46 is shown in FIGS. 6A-6B. The Ethernet isolation circuit uses an H1102 10/100 Base-T single port surface mount transformer 48 to provide the required isolation. The Ethernet isolation circuit may optionally include a 24WC32 serial EEPROM 50 for maintaining a MAC address for the microcontroller 36.

The circuit for device 10 includes a pushbutton circuit 52, which may include one or more optoisolators, such as PS2701 integrated circuits, and other components for debouncing the switch and interfacing pushbutton 26 with microcontroller 36. Such circuits for interfacing a pushbutton switch with a microcontroller or microprocessor are well known in the art, and will not be described further.

The circuit for device 10 includes a light and speaker circuit 54 for driving beacon 14, signal lights 16 and 18, and an audio alarm device that emits an alarm through speaker 28. Illumination for beacon 14 and signal lights 16 and 18 are preferably provided by an array of LEDs, and the circuitry includes current limiting resistors for limiting current through the LEDs and dissipating heat, and a driver provided by a transistor amplifier/switch, such as an ULN2803LW integrated circuit containing an array of photodarlington transistors. Such LED light circuits are conventional and well known in the art. It will be noted that the driver transistor beacon 14 and signal lights 16 and 18 may be flashed or switched on and off by the on-chip timer incorporated into microcontroller 36, or by a discrete LED flasher circuit. Speaker 24 may incorporate a horn, buzzer, or other audio alarm device driven by one of the transistor amplifier/switches of the ULN2803LW, or, alternatively, a separate and discreet speech processor circuit may be provided to furnish a verbal alarm or instruction.

The miniconnector 30 may be connected directly to microcontroller 36. The circuit for the device 10 may also include a regulated power supply circuit 56 that provides a regulated 24-volt power source for power over Ethernet to the machine controllers and sensors connected to the miniconnector port 30, as well as a regulated power supply, e.g., a 3.3-volt power supply using an LM2596 voltage regulator, for the microcontroller 36 and other circuits disposed within housing 12. Such regulated power supply circuits are well known in the art.

FIG. 7 shows an alternative embodiment of the device 100. Device 100 is enclosed within housing 112, and is substantially similar to device 10, but includes a plurality of push buttons 26a and 26b, a USB port 44, and a plurality of miniconnectors 30. The device 100 may also include a plurality of Ethernet jacks on its bottom face similar to jack 32 of FIG. 2 in order to cascade several devices 100 in series, connecting each device 100 to the next by Ethernet cable. Alternatively, the extra Ethernet port may be used for connecting anything that may operate by an Ethernet connection to the network, such as a computer, a printer, a sign, etc.

The plurality of push buttons 26a and 26b provides the operator with additional options for communicating with the HMI software. The USB port permits other devices, such as a touch screen monitor and control station, a printer, a keyboard, a mouse, or other USB device to the microcontroller 36 through conventional circuitry to expand the operator's capacity to communicate with the HMI software. The plurality of miniconnectors 30 permits additional pickup lights, buttons, sensors, and the like to be connected to the microcontroller for providing additional data inputs to the HMI software.

It will be understood that a plurality of devices 10 or devices 100 will be connected to the server computer running the HMI software by a LAN through an Ethernet hub, router, switches, or the like, or by a WAN through a gateway or other network switching device. Alternatively, the device 10 may communicate with a single computer located at the workstation via Ethernet. It will be seen that the operator interface device for an HMI system provides for generic, simple communication between Human-Machine Interface (HMI) software and an operator workstation, placing the machines and operator workstations directly under IT control from the HMI software through a computer network without the necessity for customized intervening devices or customized workstation alarm and signaling devices. It will be noted that instead of HMI software, the device may be configured to communicate with other software applications running on the server computer by a suitable driver, if desired.

A few examples will exemplify use of the present invention. A worker in an assembly line at an automotive facility attaches an emblem to the trunk of vehicles. The majority of vehicles receive a generic emblem that simply recites the make of the vehicle. A vehicle that requires a different emblem designating the vehicle as an LS model arrives at the workstation. A bar code scanner reads a bar code on the conveyor belt or on the trunk and conveys the code to the HMI software. The HMI software causes the amber “IN Station” light on the device to illuminate. The HMI software recognizes from the bar code that the vehicle requires a special emblem and beeps the horn to alert the worker. The worker presses the release push button after affixing the special emblem as a signal to the HMI software that the special emblem has been affixed, and the HMI software signal the green good job light to acknowledge and advance the assembly line. If the push button is not pushed within the allotted time for affixing the emblem, the beacon flashes and the horn wails continuously, the assembly line halting until the error is corrected and the push button depressed.

In another example, a worker at a dishwasher assembly plant uses a special tool called a torque controller to tighten the same six bolts on each dishwasher passing through the workstation. The torque controller sends an “OK” signal via Ethernet through the device to the HMI software after each bolt is tightened. The HMI software keeps count of the number of OK signals. If six are received, the green light illuminates and the conveyor belt advances. If only five OK signals are received within the allotted time, the beacon flashes and the HMI software causes the conveyor belt to stop until the error is remedied and the release button is pushed.

It is contemplated that the operator interface device for an HMI system may be used in commercial, industrial, warehouse, and manufacturing establishments. Although particularly described for use in automation systems that use HMI software, the scope of the invention is intended to extend to use with any other IT application that provides a control or monitoring system interface between a server computer and an operator workstation.

It is to be understood that the present invention is not limited to the embodiments described above, but encompasses any and all embodiments within the scope of the following claims.

I claim:

1. An operator interface device for a human-machine interface (HMI) system, comprising:
a housing adapted for mounting at an operator workstation;
at least one signal device disposed on said housing;
a serial communication port disposed on said housing adapted for connection to a serial device at the operator workstation;
at least one Ethernet port disposed on said housing adapted for connection to a network, the network having a server running HMI software connected thereto; and
a microcontroller integrated circuit chip having embedded Ethernet and at least one serial communication interface disposed thereon, the at least one signal device, the serial communication port, and the at least one Ethernet port being connected to the microcontroller, the microcontroller being configured to communicate serial communications signals between the serial device and the HMI software by TCP/IP, and to interface the HMI software with the at least one signal device in order to communicate messages between the HMI software and a human operator at the operator workstation.

2. The operator interface device according to claim 1, wherein said at least one signal device comprises a lighting circuit having an array of light emitting diodes.

3. The operator interface device according to claim 2, wherein said microcontroller comprises a circuit for flashing the array of diodes in response to a control signal from the HMI software.

4. The operator interface device according to claim 1, wherein said at least one signal device comprises a beacon disposed on top of said housing.

5. The operator interface device according to claim 4, wherein said at least one signal device further comprises a plurality of lights disposed on a front face of said housing.

6. The operator interface device according to claim 1, wherein said at least one signal device comprises a speaker configured for emitting an audio signal in response to a control signal from the HMI software.

7. The operator interface device according to claim 1, wherein said serial communications port comprises an RS-232 connector, the operator interface device further comprising an RS-232 transceiver connected between the RS-232 connector and said microcontroller.

8. The operator interface device according to claim 1, wherein said serial communications port comprises a Universal Serial Bus (USB) connector.

9. The operator interface device according to claim 1, further comprises a miniconnector adapted for connection to a machine controller at the operator workstation, the miniconnector being electrically connected to said microcontroller.

10. The operator interface device according to claim 9, wherein said miniconnector comprises an M12 connector.

11. The operator interface device according to claim 1, wherein said embedded Ethernet comprises a circuit configured for setting up a TCP/IP stack and an Ethernet transceiver.

12. The operator interface device according to claim 1, further comprising a software driver adapted for loading on the server computer running the HMI software, the driver being adapted for interfacing the HMI software with said microcontroller.

13. The operator interface device according to claim 1, wherein said at least one signal device comprises a push button disposed on said housing and a pushbutton circuit disposed between the push button and said microcontroller adapted for passing a signal from the human operator to the HMI software.

14. An operator interface device for a human-machine interface (HMI) system, comprising:
a housing adapted for mounting at an operator workstation;
a beacon disposed on top of said housing;
a plurality of signal lights disposed on a front face of said housing;
a speaker disposed on said housing;
an RS-232 connector disposed on said housing adapted for connection to a serial device at the operator workstation;
at least one Ethernet port disposed on said housing adapted for connection to a network, the network having a server running HMI software connected thereto;
a miniconnector disposed on said housing;
a microcontroller integrated circuit chip having embedded Ethernet and at least one serial communication interface disposed thereon, the at least one Ethernet port being connected to the microcontroller, the microcontroller being configured to communicate serial communications signals between the serial device and the HMI software by TCP/IP;
an RS-232 interface circuit disposed between the RS-232 connector and the microcontroller, the RS-232 circuit having an RS-232 transceiver; and
a light and speaker circuit electrically connected between the microcontroller and the beacon, the plurality of light, and the speaker in order to communicate messages between the HMI software and a human operator at the operator workstation.

15. The operator interface device according to claim 14, further comprising a push button disposed on said housing and a pushbutton circuit disposed between the push button and said microcontroller adapted for passing a signal from the human operator to the HMI software.

16. The operator interface device according to claim 14, further comprising a Universal Serial Bus (USB) connector disposed on said housing, the USB connector being electrically connected to said microcontroller.

17. A method for interfacing an operator workstation with human-machine interface (HMI) software, comprising the steps of:
locating an operator interface device at the operator workstation, the device having an audio signaling device, a visual signaling device, a pushbutton switch, a serial communications port, and a microcontroller having embedded Ethernet and a serial communications interface, the microcontroller being configured to transmit a serial communications signal received at the serial communications port by Ethernet to the HMI software;
connecting a serial device to the serial communications port;
connecting the device to a network communicating by TCP/IP, the HMI software running on a server computer connected to the network;
operating the serial device to generate a serial communications signal, the serial communications signal being automatically passed to the HMI software over the network, the HMI software automatically communicating with the microcontroller to generate a control signal in response thereto on the visual signaling device and, optionally, on the audio signaling device;
performing work on a workpiece at the operator workstation in response to the control signal; and
operating the push button in order to signal completion of the work on the workpiece to the HMI software.

18. The method for interfacing an operator workstation according to claim 17, wherein said step of connecting a serial device further comprises connecting a bar code scanner to the operator interface device, said step of operating the serial device comprising scanning a bar code with the bar code scanner.

19. The method for interfacing an operator workstation according to claim 17, further comprising the step of forming the serial communications date into at least one packet for transmission via TCP/IP over the network, the forming step being automatically performed by the microcontroller upon receipt of the serial communications signal.

20. The method for interfacing an operator workstation according to claim 17, further comprising the steps of connecting a machine controller at the operator workstation an Ethernet connector on the operator interface, the machine controller generating status signals communicated to the HMI software by the microcontroller, the microcontroller automatically generating an alarm signal on the operator interface device when the HMI software signals a condition requiring human intervention at the operator workstation in response to the status signals.
